(19) United States
(12) Patent Application Publication
(10) Pub. No.: US 2002/0148277 A1
(43) Pub. Date: Oct. 17, 2002

(54) Method of making ultrasonic probe and ultrasonic probe

(76) Inventor: Manabu Umeda, Tokyo (JP)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 10/119,921

(22) Filed: Apr. 10, 2002

(30) Foreign Application Priority Data
Apr. 11, 2001 (JP) 2001-112063

(51) Int. Cl. B29D 11/00; G01M 1/14

(52) U.S. Cl. 73/1.82; 264/1.7

(57) ABSTRACT

In order to improve manufacturing efficiency and eliminate inconvenience in washing the handle, an ultrasonic probe 100 comprises: an ultrasonic probe body 900 having an elongated trunk 905 incorporating therein ultrasonic transducers at a first end 901 of the elongated trunk 905 and having a cable 103 drawn out of a second end 902; and an angle-variable handle 910 attached to the ultrasonic probe body 900 and fabricated by thermally welding a non-slip elastomer 2 over the periphery of a hard resinous molded article 1 by composite molding.

### BACKGROUND OF THE INVENTION

The present invention relates to a method of making an ultrasonic probe and an ultrasonic probe, and more particularly to a method of making an ultrasonic probe and an ultrasonic probe that offer high manufacturing efficiency and eliminate inconvenience in washing the probe handle.

### RELATED ART

Known conventional ultrasonic probes include, for example, a transrectal probe and a transvaginal probe disclosed in. “Handbook of Medical Ultrasonic Instruments,” compiled by The Electronic Industries Association of Japan, Corona Publishing, Co. Ltd., 1997, Revised, pp. 80-81.

Such an ultrasonic probe comprises, for example, an ultrasonic probe body incorporating therein ultrasonic transducers at the tip of its elongated trunk, and a handle attached to the ultrasonic probe body for gripping.

The handle is fabricated by overlaying a non-slip rubber over the periphery of a hard resinous molded article.

The non-slip rubber is overlaid so that when an operator grips the handle it conforms to the operator's hand to prevent slipping, thereby improving operability.

In the conventional ultrasonic probes, an additional separate step of attaching the non-slip rubber to the molded article using an adhesive or the like is needed after the molded article is obtained by molding processing. This is cumbersome and lowers manufacturing efficiency.

Moreover, when the handle is removed from the ultrasonic probe body to wash the handle, the adhesive may be degenerated by a washing liquid, for example, thereby promoting detachment of the non-slip rubber.

### SUMMARY OF THE INVENTION

Therefore, it is an object of the present invention to provide a method of making an ultrasonic probe and an ultrasonic probe that offer high manufacturing efficiency and eliminate inconvenience in washing the handle.

In accordance with a first aspect, the present invention provides a method of making an ultrasonic probe, comprising the steps of: fabricating a handle by thermally welding a non-slip elastomer over the periphery of a hard resinous molded article by composite molding; and attaching the handle to an ultrasonic probe body for performing at least one of ultrasonic transmission and reception.

According to the method of making an ultrasonic probe in the first aspect, fabrication of a molded article and thermal welding of a non-slip elastomer can be performed substantially in one step by composite molding or two-color molding, so that manufacturing efficiency is improved.

Moreover, since the non-slip elastomer is integrated with the molded article on the molecular level, bonding between the elastomer and molded article can be fully enhanced and degeneration and detachment during washing can be prevented.

Furthermore, since the elastomer has a moderate elasticity and frictional property lying midway between those of a hard resin and a common rubber, the operator experiences a stable gripping feel and a good non-slip feel, thereby improving operability.

In accordance with a second aspect, the present invention provides the method of making an ultrasonic probe of the aforementioned configuration, wherein a material of the hard resin consists of PP, PBT, ABS, PE, PS, TPX, POM, PVC or PPE, or combinations of at least two of the foregoing.

In the method of making an ultrasonic probe of the second aspect, since the molded article is fabricated from PP (polypropylenes), PBT (polybutylene terephthalates), ABS (acrylonitrile-butadiene-styrenes), PE (polyethylenes), PS (polystyrenes), TPX (polymethylpentenes), POM (polyacetals), PVC (polyvinyl chlorides), PPE (polyphenylene ethers) or their composite resins, chemical resistance, heat resistance, impact resistance and moldability etc. can be improved.

In accordance with a third aspect, the present invention provides the method of making an ultrasonic probe of the aforementioned configuration, wherein the hardness of the non-slip elastomer ranges from A65 to A95.

In the method of making an ultrasonic probe of the third aspect, since the hardness of the non-slip elastomer ranges from A65 to A95, the non-slip elastomer can be prevented from excessively deforming when the handle is gripped and a suitable gripping feel can be given to the operator.

In accordance with a fourth aspect, the present invention provides the method of making an ultrasonic probe of the aforementioned configuration, wherein a material of the non-slip elastomer consists of styrene thermoplastic elastomers, olefinic thermoplastic elastomers, urethane thermoplastic elastomers, ester thermoplastic elastomers, chlorinated polyethylene thermoplastic elastomers or polyvinyl chloride thermoplastic elastomers, or combinations of at least two of the foregoing.

In the method of making an ultrasonic probe of the fourth aspect, since the non-slip elastomer is made from one or more of several thermoplastic elastomers of excellent processability, mass producibility can be improved.

In accordance with a fifth aspect, the present invention provides the method of making an. ultrasonic probe of the aforementioned configuration, wherein the thickness of the non-slip elastomer ranges from 0.1 mm to 10 mm.

In the method of making an ultrasonic probe of the fifth aspect, since the thickness of the non-slip elastomer ranges from 0.1 mm to 10 mm, the handle can be made to conform well to the operator's hand, and fitting snugness felt when the handle is gripped can be further improved.

In accordance with a sixth aspect, the present invention provides the method of making an ultrasonic probe of the aforementioned configuration, wherein the non-slip elastomer is formed only over a portion of the peripheral surface of the molded article that is gripped by the operator's hand.

In the method of making an ultrasonic probe of the sixth aspect, since the non-slip elastomer is formed only over the portion which is gripped, inconvenience of the hand gripping the handle accidentally slipping can be further reduced. Moreover, a design accent can be imparted for better aesthetics.

In accordance with a seventh aspect, the present invention provides the method of making an ultrasonic probe of the aforementioned configuration, wherein the handle is attached so that an angle between a central axis of the handle and a central axis of the ultrasonic probe body is changed when the handle is rotated around its central axis.

In the method of making an ultrasonic probe of the seventh aspect, by rotating the handle around its central axis, an angle between a central axis of the handle and a central axis of the ultrasonic probe body can be selected according to an application, and operability is improved.

In accordance with an eighth aspect, the present invention provides the method of making an ultrasonic probe of the aforementioned configuration, wherein a screw is provided at a pivot around which an angle between the central axis of the handle and the central axis of the ultrasonic probe body can be changed.

In the method of making an ultrasonic probe of the eighth aspect, by fastening the screw, an angle between the central axis of the handle and the central axis of the ultrasonic probe body can be fixed; and by loosening the screw, the angle can be changed. Therefore, fine angular control is enabled by adjusting the screw, and operability is further improved.

In accordance with a ninth aspect, the present invention provides an ultrasonic probe comprising: an ultrasonic probe body having ultrasonic transducers at an end of its elongated trunk, the end portion being inserted into a body cavity of a subject to perform at least one of ultrasonic transmission and reception; and a handle attached to the ultrasonic probe body and fabricated by thermally welding a non-slip elastomer over the periphery of a hard resinous molded article by composite molding.

According to the ultrasonic probe in the ninth aspect, the method of making an ultrasonic probe of the first aspect can be suitably implemented.

In accordance with a tenth aspect, the present invention provides the ultrasonic probe of the aforementioned configuration, wherein a material of the hard resin consists of PP, PBT, ABS, PE, PS, TPX, POM, PVC or PPE, or combinations of at least two of the foregoing.

According to the ultrasonic probe in the tenth aspect, the method of making an ultrasonic probe of the second aspect can be suitably implemented.

In accordance with an eleventh aspect, the present invention provides the ultrasonic probe of the aforementioned configuration, wherein the hardness of the non-slip elastomer ranges from A65 to A95.

According to the ultrasonic probe in the eleventh aspect, the method of making an ultrasonic probe of the third aspect can be suitably implemented.

In accordance with a twelfth aspect, the present invention provides the ultrasonic probe of the aforementioned configuration, wherein a material of the non-slip elastomer consists of styrene thermoplastic elastomers, olefinic thermoplastic elastomers, urethane thermoplastic elastomers, ester thermoplastic elastomers, chlorinated polyethylene thermoplastic elastomers or polyvinyl chloride thermoplastic elastomers, or combinations of at least two of the foregoing.

According to the ultrasonic probe in the twelfth aspect, the method of making an ultrasonic probe of the fourth aspect can be suitably implemented.

In accordance with a thirteenth aspect, the present invention provides the ultrasonic probe of the aforementioned configuration, wherein the thickness of the non-slip elastomer ranges from 0.1 mm to 10 mm.

According to the ultrasonic probe in the thirteenth aspect, the method of making an ultrasonic probe of the fifth aspect can be suitably implemented.

In accordance with a fourteenth aspect, the present invention provides the ultrasonic probe of the aforementioned configuration, wherein the non-slip elastomer is formed only over a portion of the peripheral surface of the molded article that is gripped by the operator's hand.

According to the ultrasonic probe in the fourteenth aspect, the method of making an ultrasonic probe of the sixth aspect can be suitably implemented.

In accordance with a fifteenth aspect, the present invention provides the ultrasonic probe of the aforementioned configuration, wherein an angle between a central axis of the handle and a central axis of the ultrasonic probe body is changed by rotating the handle around its central axis.

According to the ultrasonic probe in the fifteenth aspect, the method of making an ultrasonic probe of the seventh aspect can be suitably implemented.

In accordance with a sixteenth aspect, the present invention. provides the ultrasonic probe of the aforementioned configuration, wherein a screw is provided at a pivot around which an angle between the central axis of the handle and the central axis of the ultrasonic probe body can be changed.

According to the ultrasonic probe in the sixteenth aspect, the method of making an ultrasonic probe of the eighth aspect can be suitably implemented.

According to the method of making an ultrasonic probe and the ultrasonic probe of the present invention, the following effects can be obtained:

(1) Since the non-slip elastomer is formed only over a grip portion of the handle, the elastomer conforms to the handle of the ultrasonic probe and prevents the handle from slipping, thereby allowing operation without stressing the hand.

(2) Since the non-slip elastomer is firmly integrated with the hard resinous molded article, it can be prevented from detaching even if it is repeatedly washed. Moreover, since no gap or the like is formed at the boundary between the non-slip elastomer and the molded article, complete washing can be achieved and corrosion by chemicals and the like can be reduced.

Further objects and advantages of the present invention will be apparent from the following description of the preferred embodiments of the invention as illustrated in the accompanying drawings.

### BRIEF DESCRIPTION OF THE DRAWINGS

FIG. 1 is a left side view of an ultrasonic probe in accordance with one embodiment of the present invention.

FIG. 2 is a plan view of the ultrasonic probe shown in FIG. 1.

FIG. 3 is a front view of the ultrasonic probe shown in FIG. 1.

FIG. 4 is a right side view of a main portion of the ultrasonic probe shown in FIG. 1.

FIG. 5 is another left side view of the ultrasonic probe shown in FIG. 1.

FIG. 6 is a left side view of an ultrasonic probe body of the ultrasonic probe shown in FIG. 1.

FIG. 7 is a plan view of the ultrasonic probe body of the ultrasonic probe shown in FIG. 1.

FIG. 8 is a flow chart showing the steps in the manufacture of the ultrasonic probe shown in FIG. 1.

FIG. 9 is a left side view of a molded article.

FIG. 10 is a left side view of an angle-variable handle.

FIG. 11 is a right side view of the angle-variable handle.

FIG. 12 is a plan view of the angle-variable handle.

FIG. 13 is a vertical cross-sectional view of the angle-variable handle.

### DETAILED DESCRIPTION OF THE INVENTION

The present invention will now be described in detail with reference to embodiments shown in the accompanying drawings. It should be noted that the present invention is not limited to these embodiments.

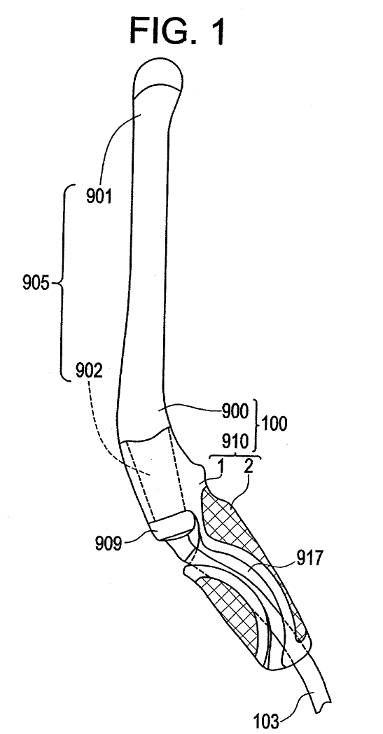

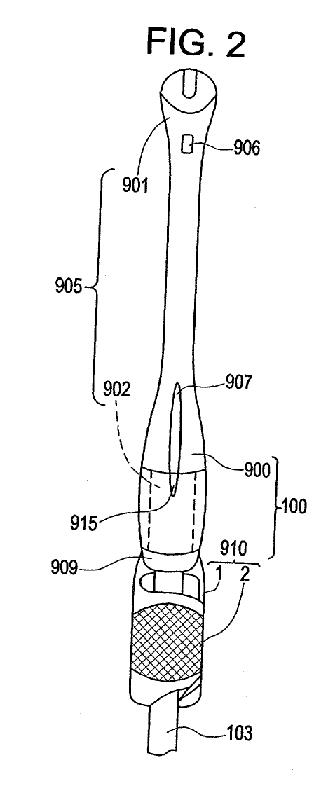

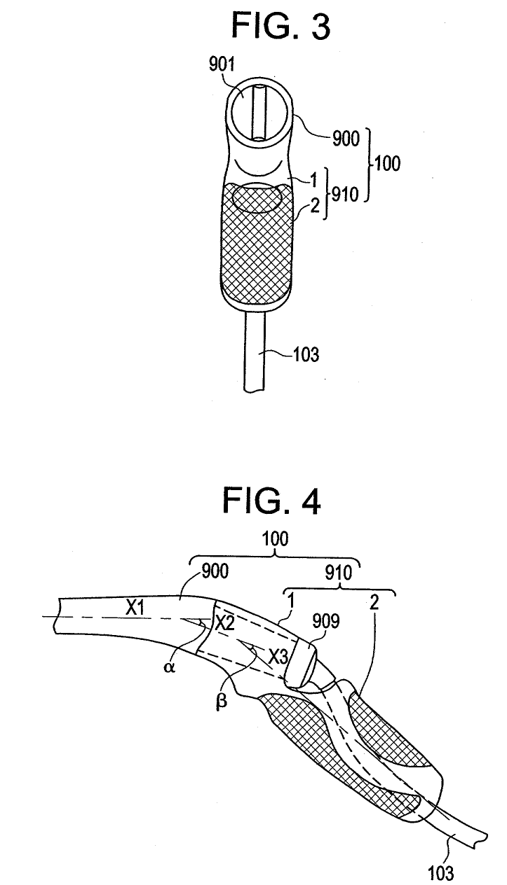

FIG. 1 is a left side view of an ultrasonic probe 100 in accordance with one embodiment of the present invention; FIG. 2 is a plan view of the ultrasonic probe 100; and FIG. 3 is a front view of the ultrasonic probe 100.

The ultrasonic probe 100 comprises: an ultrasonic probe body 900 having an elongated trunk 905 incorporating therein ultrasonic transducers (not shown) at a first end 901 and having a cable 103 drawn out of a second end 902; and an angle-variable handle 910 attached using a screw cap 909 that can be rotated by a finger toward the second end 902 of the ultrasonic probe body 900.

The angle-variable handle 910 has a slit 917 and a cavity which the cable 103 can pass through. Moreover, the angle-variable handle 910 is fabricated by thermally welding, by composite molding, a non-slip elastomer 2 (indicated as a cross-hatched region) having a hardness of A65 -A95 and a thickness of 0.1 mm-10 mm over a portion of the peripheral surface of the hard resinous molded article 1 that is gripped by the operator's hand.

The elongated trunk 905 is provided with recesses 906 and 907 for locking a puncture guide. The first end 901 of the elongated trunk 905 can be inserted into a body cavity of a subject to perform at least one of ultrasonic transmission and reception.

The angle-variable handle 910 is also provided with a recess 915 for locking the puncture guide.

FIG. 4 is a right side view of the main portion of the ultrasonic probe 100.

A central axis X1 on the side of the first end 901 and a central axis X2 on the side of the second end 902 form an angle α(5°≦α≦45°). Moreover, the angle-variable handle 910 can be made rotatable around the central axis X2 on the side of the second end 902 by loosening the screw cap 909. Furthermore, the central axis X2 on the side of the second end 902 and a central axis X3 of the angle-variable handle 910 form an angle β(5°≦β≦45°)

Consequently, the central axis X1 on the side of the first end 901 and the central axis X3 of the angle-variable handle 910 form an angle α+β(10°≦α+β≦90°) in the condition shown in FIGS. 1-4.

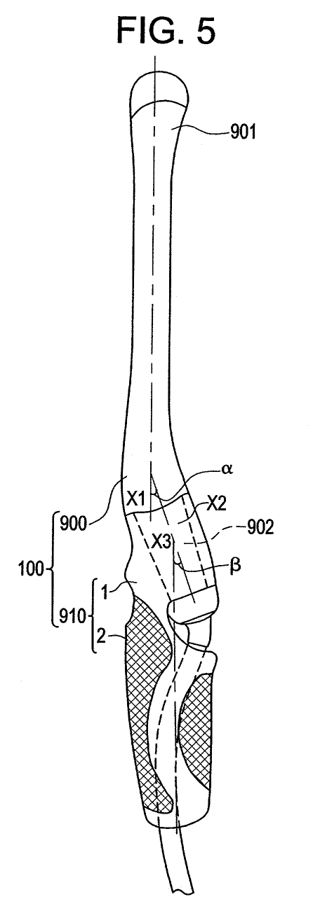

FIG. 5 shows the condition after loosening the screw cap 909, rotating the angle-variable handle 910 around the central axis X2 on the side of the second end 902 by 180°, and tightening the screw cap 909 again to fix the angle.

In this condition, the central axis X1 on the side of the first end 901 and the central axis X3 of the angle-variable handle 910 form an angle α-β(−40°≦α−β≦40°).

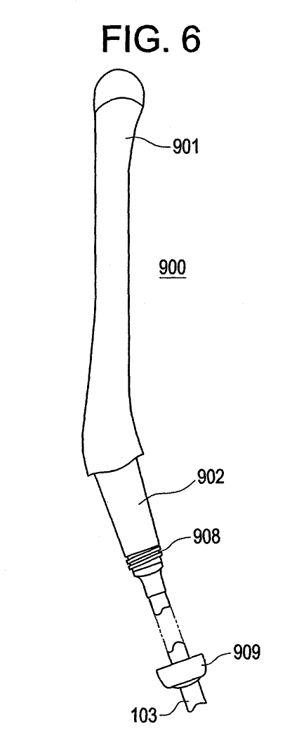

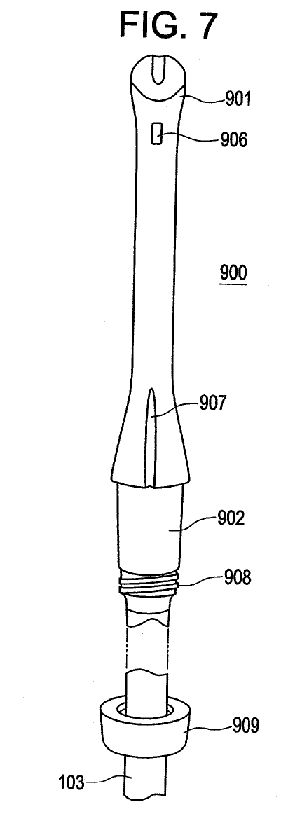

FIG. 6 is a left side view of the ultrasonic probe body 900; and FIG. 7 is a plan view of the ultrasonic probe body 900.

The second end 902 is provided with a thread 908 engaged with the screw cap 909.

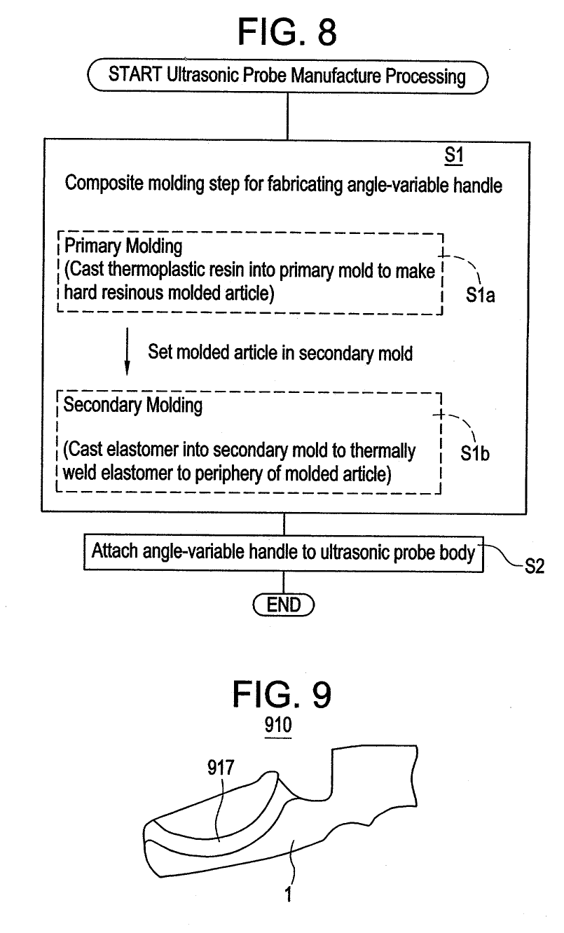

FIG. 8 is a flow chart showing the steps in the manufacture of the ultrasonic probe 100.

Step S1 is a composite molding step for fabricating the angle-variable handle 910. Although this is substantially one step (for example, a step that can be sequentially performed by a single molding machine for heterogeneous materials), the step will be described below by dividing it into an earlier step and a later step for convenience of explanation.

Specifically, in the earlier step S1a, a thermoplastic resin is cast into a primary mold (not shown) heated to a resin melting temperature (for example, 100° C. or higher) using an injection apparatus etc., to make a molded article 1 of the angle-variable handle 910. The material of the thermoplastic resin consists of, for example, PP, PBT, ABS, PE, PS, TPX, POM, PVC or PPE, or combinations of at least two of the foregoing. FIG. 9 exemplarily shows a left side view of the molded article 1. After being solidified, the molded article 1 is set in a secondary mold.

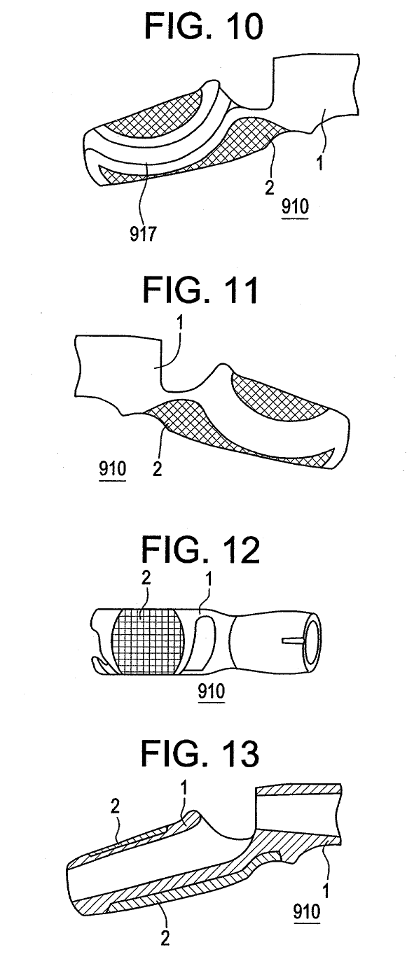

Subsequently, in the later step S1b, an elastomer is cast into the secondary mold heated to an elastomer melting temperature (for example, lower than 100° C.), and a non-slip elastomer 2 is thermally welded over the periphery of the molded article 1. The material of the non-slip elastomer consists of, for example, styrene thermoplastic elastomers, olefinic thermoplastic elastomers, urethane thermoplastic elastomers, ester thermoplastic elastomers, chlorinated polyethylene thermoplastic elastomers or polyvinyl chloride thermoplastic elastomers, or combinations of at least two of the foregoing. Thus, the angle-variable handle 910 is fabricated. FIG. 10 is a left side view of the angle-variable handle 910; FIG. 11 is a right side view of the angle-variable handle 910; FIG. 12 is a plan view of the angle-variable handle 910; and FIG. 13 is a vertical cross-sectional view of the angle-variable handle 910.

In Step S2, the angle-variable handle 910 is attached to the ultrasonic probe body 900. Thus, the ultrasonic probe 100 described with reference to FIGS. 1-5 is completed.

In the method of making the ultrasonic probe 100 as described above, the angle-variable handle 910 can be fabricated in substantially one step (i.e., a composite molding step of making the hard resinous molded article 1 and thermally welding the non-slip elastomer 2 over the periphery of the article 1), so that manufacturing efficiency can be improved. Moreover, since the non-slip elastomer 2 is firmly bonded to molded article 1, it can be prevented from detaching even if it is repeatedly washed.

Instead of rotating the angle-variable handle 910 around its central axis to change the angle between the central axis of the angle-variable handle 910 and the central axis of the ultrasonic probe body 900, a screw may be provided at a pivot around which the angle between the central axis of the angle-variable handle 910 and the central axis of the ultrasonic probe body 900 can be changed.

Many widely different embodiments of the invention may be constructed without departing from the spirit and the scope of the present invention. It should be understood that the present invention is not limited to the specific embodiments described in the specification, except as defined in the appended claims.

1. A method of making an ultrasonic probe, comprising the steps of: fabricating a handle by thermally welding a non-slip elastomer over the periphery of a hard resinous molded article by composite molding; and attaching said handle to an ultrasonic probe body for performing at least one of ultrasonic transmission and reception.

2. The method of making an ultrasonic probe as defined in claim 1, wherein a material of said hard resin consists of PP, PBT, ABS, PE, PS, TPX, POM, PVC or PPE, or combinations of at least two of the foregoing.

3. The method of making an ultrasonic probe as defined in claim 1 or 2, wherein the hardness of said non-slip elastomer ranges from A65 to A95.

4. The method of making an ultrasonic probe as defined in any one of claims 1-3, wherein a material of the non-slip elastomer consists of styrene thermoplastic elastomers, olefinic thermoplastic elastomers, urethane thermoplastic elastomers, ester thermoplastic elastomers, chlorinated polyethylene thermoplastic elastomers or polyvinyl chloride thermoplastic elastomers, or combinations of at least two of the foregoing.

5. The method of making an ultrasonic probe as defined in any one of claims 1-4, wherein the thickness of said non-slip elastomer ranges from 0.1 mm to 10 mm.

6. The method of making an ultrasonic probe as defined in any one of claims 1-5, wherein said non-slip elastomer is formed only over a portion of the peripheral surface of said molded article that is gripped by the operator's hand.

7. The method of making an ultrasonic probe as defined in any one of claims 1-6, wherein said handle is attached so that an angle between a central axis of said handle and a central axis of said ultrasonic probe body is changed when said handle is rotated around its central axis.

8. The method of making an ultrasonic probe as defined in any one of claims 1-7, wherein a screw is provided at a pivot around which an angle between the central axis of said handle and the central axis of said ultrasonic probe body can be changed.

9. An ultrasonic probe comprising: an ultrasonic probe body having ultrasonic transducers at an end of its elongated trunk, said end portion being inserted into a body cavity of a subject to perform at least one of ultrasonic transmission and reception; and a handle attached to said ultrasonic probe body and fabricated by thermally welding a non-slip elastomer over the periphery of a hard resinous molded article by composite molding.

10. The ultrasonic probe as defined in claim 9, wherein a material of said hard resin consists of PP, PBT, ABS, PE, PS, TPX, POM, PVC or PPE, or combinations of at least two of the foregoing.

11. The ultrasonic probe as defined in claim 9 or 10, wherein the hardness of said non-slip elastomer ranges from A65 to A95.

12. The ultrasonic probe as defined in any one of claims 9-11, wherein a material of said non-slip elastomer consists of styrene thermoplastic elastomers, olefinic thermoplastic elastomers, urethane thermoplastic elastomers, ester thermoplastic elastomers, chlorinated polyethylene thermoplastic elastomers or polyvinyl chloride thermoplastic elastomers, or combinations of at least two of the foregoing.

13. The ultrasonic probe as defined in any one of claims 9-12, wherein the thickness of said non-slip elastomer ranges from 0.1 mm to 10 mm.

14. The ultrasonic probe as defined in any one of claims 9-13, wherein said non-slip elastomer is formed only over a portion of the peripheral surface of said molded article that is gripped by the operator's hand.

15. The ultrasonic probe as defined in any one of claims 9-14, wherein an angle between a central axis of said handle and a central axis of said ultrasonic probe body is changed by rotating said handle around its central axis.

16. The ultrasonic probe as defined in any one of claims 9-15, wherein a screw is provided at a pivot around which an angle between the central axis of said handle and the central axis of said ultrasonic probe body can be changed.
